(19) United States
(12) Patent Application Publication
(10) Pub. No.: US 2007/0145197 A1
(43) Pub. Date: Jun. 28, 2007

(54) Timepiece

(76) Inventors: Haruki Hiranuma, Chiba-shi (JP); Nobukazu Omori, Chiba-shi (JP)

Correspondence Address: BRUCE L. ADAMS, ESQ.;SUITE 1231, 17 BATTERY PLACE, NEW YORK, NY, 10004, US

(21) Appl. No.: 11/635,472

(22) Filed: Dec. 7, 2006

(30) Foreign Application Priority Data
Dec. 26, 2005 (JP) 2005-372821

(51) Int. Cl. G12B 9/00

(52) U.S. Cl. 248/27.1

(57) ABSTRACT

To provide a timepiece in which it has been made possible to exchange an edge member, to which a glass has been fixed, without accompanying a case band. A wristwatch comprises an annular case band, a case back, an annular edge member, a glass, and a snap ring. A front side end part of the case band forming a fitting hole has an edge receiving face around the fitting hole and an engaging back face. A case back is detachably attached to a back side end part of the case band. The glass is fitted and fixed to an annular step part having been formed in the edge member. In the edge member there are provided a tubular part penetrating through the fitting hole so as to be capable of being inserted and disengaged, and a cover part overlapping with the edge receiving face. In the tubular part there is provided an annular attaching groove opening to an outer periphery of the tubular part. A snap ring is formed in a C-shaped form by a material having an elasticity. Under a state that the case back has been detached, the tubular part is detachably attached to the front side end part by nipping the front side end part by the snap ring, which is attached/detached to/from the attaching groove and catches to the engaging back face, and the cover member.

### BACKGROUND OF THE INVENTION

1. Field of the Invention

The present invention relates to a timepiece such as a potable watch like, e.g., wristwatch and pocket watch, a desk clock and a wall-mounted clock.

2. Description of the Prior Art

Hitherto, among wristwatches possessing a case back, there is known a wristwatch in which an annular protrusion part is formed in an inner periphery of a front side end part of a case band in which a dial is accommodated, to the inner periphery of this annular protrusion part, a glass covering the dial is fitted and fixed and a tubular member of an edge member functioning also as a bezel is fitted, and a caulking part integral with this tubular part has been caulked to a back face of the annular protrusion part (for example, refer to JP-UM-B-5-37273 Gazette).

In the wristwatch in which the edge member has been caulked to the case band as mentioned above, since the fact that a caulked part having been deformed is caulked again after having been returned to a state before being caulked extremely decreases a mechanical strength of the caulked part, it is impossible to detach the edge member from the case band. For this reason, in a case where the edge member has been impaired, a user of the wristwatch is obliged to exchange not only the edge member to which the glass has been fixed but also the case band to which this edge member has been caulked.

Further, in a wristwatch in which a waterproofness has been intended by nipping a seal packing between the case band and the edge member, there is considered the fact that a performance of the seal packing decreases during a long period guarantee term of the wristwatch and thereafter. Also in a case where, in order to cope with this, it is attempted to exchange the seal packing, since it is possible to detach the edge member from the case band, it is obliged to exchange not only the edge member but also the case band to which this edge member has been caulked.

### SUMMARY OF THE INVENTION

An object of the present invention is to provide a timepiece in which it has been made possible to exchange the edge member to which the glass has been fixed, without accompanying the case band.

The present invention comprises an annular case band which has a front side end part forming a fitting hole, and in which this end part has an edge receiving face around the fitting hole and an engaging back face continuous so as to bulge around the fitting hole, a case back having been detachably attached to a back side end part of the case band, an annular edge member which has a tubular part fitted so as to be capable of being inserted into and disengaged from the fitting hole and a cover part overlapped with the edge receiving face, and in which in the tubular part there has been formed an annular attaching groove opening to an outer periphery of the tubular part, a glass having been fitted and fixed to an annular step part having been formed in the edge member, and a snap ring which is formed in a C-shaped form by a material having an elasticity, which is detachably attached to the attaching hole, in which the front side end part is nipped between it and the cover part while catching to the engaging back face, and which is attached/detached under a state that the case back has been detached.

In the present invention, the edge receiving face may be provided continuously so as to bulge from a front side open end of the fitting hole to its periphery, or may be provided by forming a step between it and the front side open end such that the front side open end and the edge receiving face exist in different height positions about a thickness direction of the case band. Further, the edge receiving face and a contact face, of the cover part, contacting with the former is not limited to a plane, along a direction perpendicularly intersecting with a thickness direction of the case band, and may be a slant face along a direction slantingly intersecting with the thickness direction of the case band or a curved face curving along the direction slantingly intersecting with the thickness direction of the case band.

In the present invention, the outer periphery of the tubular part and the fitting hole into which this tubular part is inserted may be a circular shape or a polygonal shape. In the present invention, a fixation of the glass to the annular step part of the edge member may be fixed by using an adhesive, or pressure-inserting the glass to the annular step part with a seal part having an elasticity being nipped between it and the annular step part.

In the present invention, the snap ring of a C-shaped form or the like can be suitably formed by a metal which can elastically deform, and the like. Together with this, as to a sectional shape of the snap ring, a quadrangle is desirable in a viewpoint of more largely ensuring a catching margin to the engaging back face, and more desirably it suffices if it is made a long quadrangle whose thickness is thin. However, a sectional shape of the snap ring may be a circular shape. Further, in the present invention, a sectional shape of the attaching groove formed in the tubular part is not limited to correspond to the sectional shape of the snap ring, and it can be made a V-shaped form in section irrespective of the sectional shape of the snap ring. In the latter case, it is possible to prevent an unsteadiness of the snap ring, which results from a dimensional dispersion of the annular attaching groove and a dispersion in a sectional dimension of the snap ring. For this reason, it is preferable in a point that an attachment of the edge member to the case band is more easily stabilized by strengthening a nipping to the front side end part by the snap ring and the cover part.

In the present invention, a state that the cover part of the edge member has been overlapped with the edge receiving face of the case band by the fact that the tubular part of the edge member to which the glass has been fixed is inserted into the fitting hole of the case band, is held by the snap ring having been accommodated inside the case band and disposed over the engaging back face of the front side end part and the attaching groove of the tubular part, and this snap ring can be attached/detached under a state that the case back has been opened. For this reason, in a case where the edge member has been impaired or the like, the edge member can be attached to and detached from the case band by attaching/detaching the snap ring. Accordingly, the edge member to which the glass has been fixed can be exchanged without accompanying the case band.

In a preferred mode of the present invention, there is possessed an annular seal packing having been nipped between the edge receiving face and the cover part under a compressed state. Here, the seal packing may be provided by annularly forming a holding groove in either of the edge receiving face and the cover part and fitting it to this holding groove, or also can be provided without forming such a holding groove.

In this preferred mode, as already mentioned, since an incorporation and a separation of the edge member with respect to the case band can be performed by the attachment/detachment of the snap ring, in a case where a performance of the seal packing bearing a waterproofness/dustproofness between the edge receiving face and the cover part has decreased, it is possible to exchange this packing without accompanying at least the case band between the case band and the edge member.

Additionally, in a preferred mode of the present invention, at least one part of the snap ring is made an operating part when the snap ring is detached from the attaching groove by protruding it from the outer periphery of the tubular part and, between the operating part and the tubular part, there is formed a wedge-like tool inserting gap when it is seen from the case back side.

In this preferred mode, since there is previously formed the tool inserting gap into which a tool for detaching the snap ring is inserted under a state that the snap ring has been attached to the tubular part, it is possible, when the edge member is detached form the case band, to detach the snap ring from the tubular part by opening this snap ring while resisting against its elasticity after easily inserting a tip of the tool into the tool inserting gap.

Further, in a preferred mode of the present invention, a tool inserting small hole is provided in a site having been separated from the tubular part in at least one end part of the snap ring, and thereby the one end part is made an operating part when the snap ring is detached from the attaching groove.

In this preferred mode, since there is located, outside the tubular part, the tool inserting small hole into which the tool for detaching the snap ring is inserted under the state that the snap ring has been attached to the tubular part, it is possible, when the edge member is detached form the case band, to detach the snap ring from the tubular part by opening this snap ring while resisting against its elasticity after easily inserting the tip of the tool into the tool inserting small hole.

Further, in a preferred mode of the present invention, the glass is fixed to the annular step part by an adhesive.

In this preferred mode, since the attachment/detachment of the edge member to/from the tubular part of the edge member is performed without giving an excessive strain to the edge member, there is no fear that the glass is exfoliated with the strain of the edge member which is caused when the edge member to/from the case band is attached/detached. Moreover, in addition to the fact that a periphery face of the glass is bonded to an annular periphery face of the annular step part along a thickness direction of the edge member, since a periphery part back face of the glass is bonded to a seat face continuous perpendicularly to the annular periphery face, a bonding area can be largely ensured. For this reason, it is possible to thin a thickness of the edge member while ensuring a necessary bonding area with respect to the glass.

### BRIEF DESCRIPTION OF THE SEVERAL VIEWS OF THE DRAWINGS

A preferred form of the present invention is illustrated in the accompanying drawings in which:

FIG. 1 is a plan view showing a wristwatch concerned with a first embodiment of the present invention;

FIG. 2 is a sectional view showing one part of the wristwatch of FIG. 1, while being enlarged;

FIG. 3 is a sectional view showing along an arrow line F3-F3 in FIG. 2;

FIG. 4 is a perspective view showing one part of an edge member that the wristwatch of FIG. 1 possesses, while being seen from an outside;

FIG. 5 is a perspective view showing one part of the edge member that the wristwatch of FIG. 1 possesses, while being seen from an inside;

FIG. 6 is a perspective view showing a snap ring that the wristwatch of FIG. 1 possesses;

FIG. 7 is a sectional view showing a wristwatch concerned with a second embodiment of the present invention, which corresponds to FIG. 2;

FIG. 8 is a perspective view showing a snap ring that the wristwatch of FIG. 7 possesses;

FIG. 9A is a plan view showing a snap ring that a wristwatch concerned with a third embodiment of the present invention possesses; and FIG. 9B is a perspective view showing the same snap ring.

### DETAILED DESCRIPTION OF THE PREFERRED EMBODIMENTS

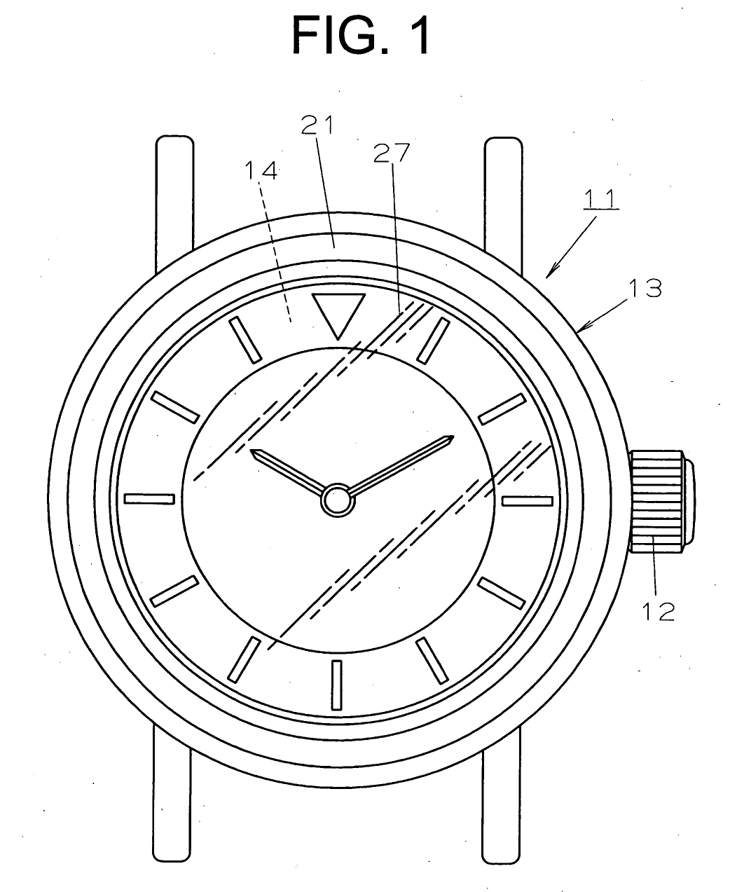

A first embodiment of the present invention is explained by referring to FIG. 1 through FIG. 6.

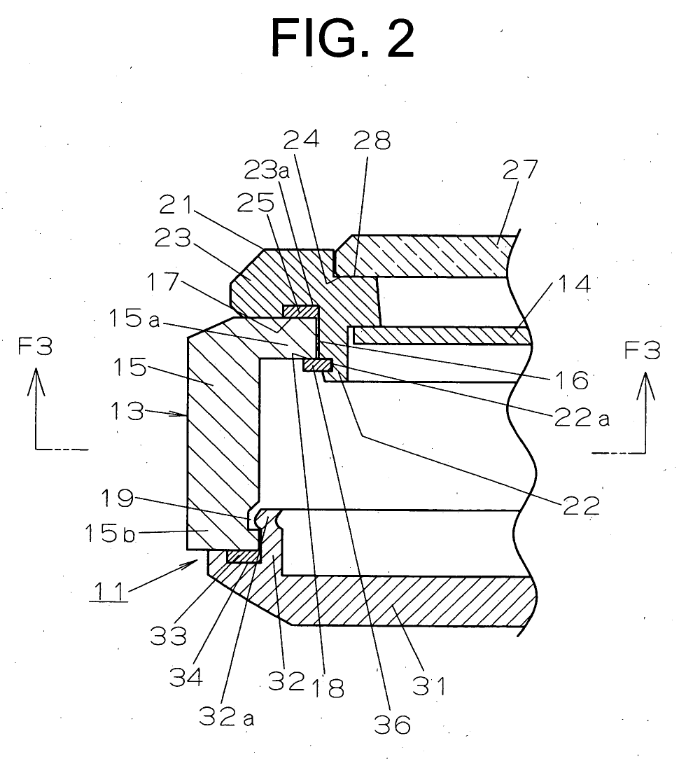

In FIG. 1, a reference numeral 11 denotes a timepiece, e.g., a portable timepiece having possessed a function capable of screw-locking a crown 12, concretely a wristwatch. As shown in FIG. 2, the wristwatch 11 accommodates, in its timepiece armor assembly 13, a dial 14, a timepiece movement not shown in the drawing, and the like. The timepiece movement may be any of one whose power has been made a small battery or a main spring, or automatically winding one, or one corresponding to a digital timepiece which digital-displays a time instant and the like on the dial 14 by a quartz oscillation module, or one in which the one corresponding to the digital time piece and one other than it have been used in combination, or the like.

As shown in FIG. 2, the timepiece armor assembly 13 is formed by mounting a glass 27 to a front side of an annular case band 15 through an edge member 21, and liquid-tightly mounting a case back 31 consisting of a metal or the like to a back side of the case band 15.

The case band 15 consists of a metal such as stainless steel and titanium or a synthetic resin. The case band 15 has a front side end part 15a. This front side end part 15a is protruded toward an inner hollow part of the case band 15, and a fitting hole 16 is formed in a front side site of the case band 15. The fitting hole 16 is circular for instance.

A surface of the front side end part 15a forms an edge receiving face 17. This edge receiving face 17 is formed by a plane continuous perpendicularly to the fitting hole 16 so as to extend, e.g., from a front side open end of the fitting hole 16 to its periphery. A back face of the front side end part 15a forms an engaging back face 18. This engaging back face 18 is formed by a plane continuous perpendicularly to the fitting hole 16 so as to extend from a back side open end of the fitting hole 16 to its periphery. The edge receiving face 17 and the engaging back face 18 are parallel.

A locking groove 19 is formed in an inner face of a back side end part 15b of the case band 15. The case back 31 is detachable with respect to the case band 15 from its back side. For this reason, the case back 31 integrally has an in-case-band insertion tubular part 32 which is elastically deformable, and engaging convex parts 32a (only one is shown in the drawing) are formed in several places of a tip part of the in-case-band insertion tubular part 32.

Accordingly, by inserting the in-case-band insertion tubular part 32 into a back side opening of the case band 15, the engaging convex part 32a is caught by the engaging groove 19 at the same time as this engaging convex part 32a climbs over a lower side edge of the engaging groove 19 while accompanying an elastic deformation of the in-case-band insertion tubular part 32, so that it is possible to mount the case back 31 to the case band 15. Under this attached state, it is possible to detach the case back 31 from the case band 15 by inserting a tip part of a tool such as minus driver not shown in the drawing into a peripheral part of the case back 31 and the back side end part 15b to thereby detach the engaging convex part 32a from the engaging groove 19 by wrenching the case back 31. Incidentally, in FIG. 2, a reference numeral 33 denotes an annular packing made of a resinous elastic material. The seal packing 33 is nipped under a compressed state by the case band 15 and the case back 31, bears the waterproofness/dustproofness between them, and is fitted and attached, e.g., to a holding groove 34 having been provided in the case back 31.

The edge member 21 is one used as, e.g., a glass edge holding the glass 27, and is annularly formed by the metal such as stainless steel and titanium or the synthetic resin. As shown in FIG. 2 and FIG. 5, the edge member 21 has integrally a tubular part 22, a cover part 23 and an annular step part 24.

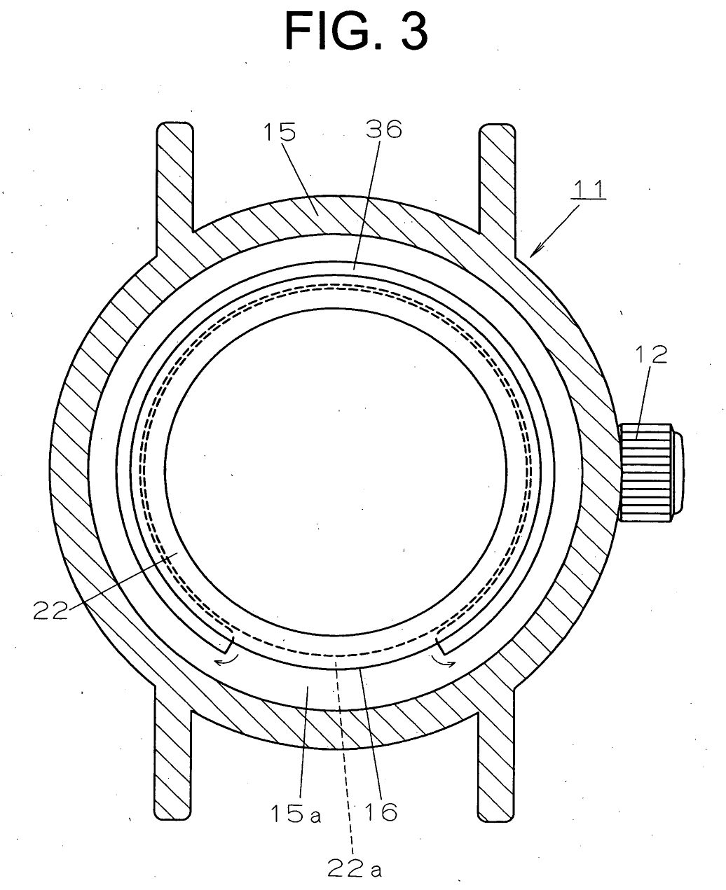

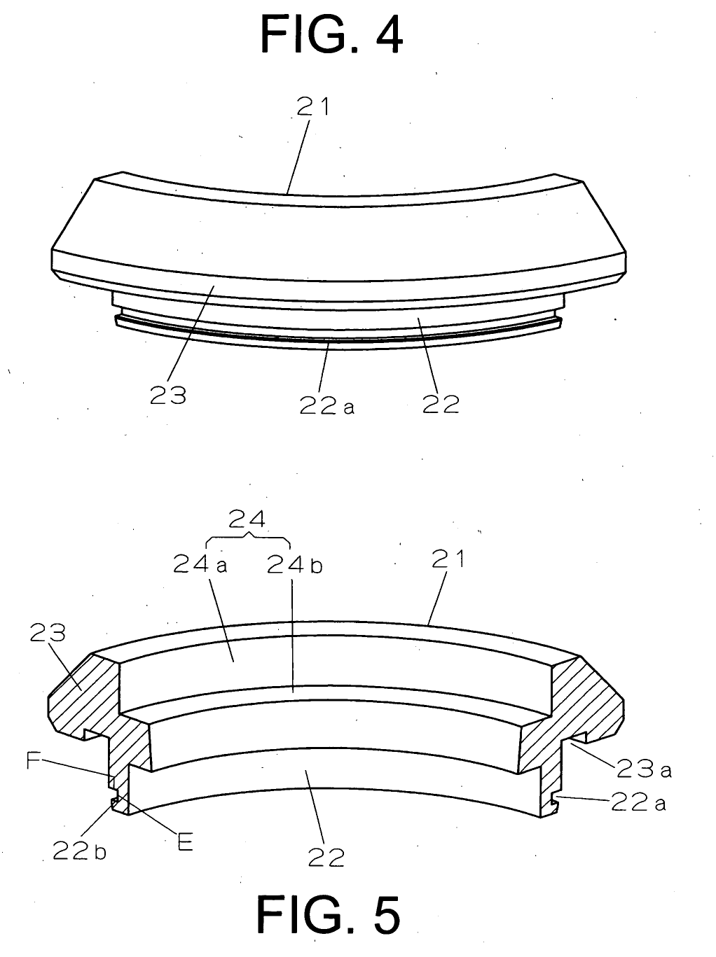

The tubular part 22 is one fitted to the fitting hole 16 so as to be capable of being inserted into and disengaged from the same and, as shown in FIG. 3, forms a cylindrical shape for instance. As shown in FIG. 2, a height of the tubular part 22 is longer than a thickness of the front side end part 15a of the case band 15. As shown in FIG. 2 and FIG. 4, in a tip part of the tubular part 22, there is formed an annular attaching groove 22a which opens to an outer periphery face. Additionally, an outer periphery of a tip site extending from the attaching groove 22a to a tip face of the tubular part 22 becomes a taper face 22b in which this tip site is tapered. A sectional shape of the attaching groove 22a is a quadrangle for instance.

The cover part 23 is a site overlapped to the edge receiving face 17 of the front side end part 15a. In a back face of this cover part 23, there is formed an annular holding groove 23a. To this holding groove 23a, an annular seal packing 25 (refer to FIG. 2) made of the resinous elastic material is fitted. A thickness of the seal packing 25 under its free state is larger than a depth of the holding groove 23a.

As shown in FIG. 5, the annular step part 24 having been provided in an inner periphery side site of the edge member 21 is formed by an annular periphery face 24a and a seat face 24b. The annular periphery face 24a is provided along a thickness direction of the edge member 21, and the seat face 24b is formed continuously, perpendicularly to the annular periphery face 24a. It is desirable that an area of the seat face 24b is larger than an area of the annular periphery face 24a. The glass 27 is fitted and fixed to this annular step part 24 through an adhesive 28 (refer to FIG. 2).

The fixation of the glass 27 to the edge member 21 is performed by fitting the glass 27 to the annular step part 24 after the adhesive 28 has been applied to a corner part that the annular periphery face 24a and the seat face 24b form. By this, the adhesive 28 between the annular step part 24 and a periphery part of the glass 27 is extended along the annular periphery face 24a and the seat face 24b, the periphery face of the glass 27 contacting with the annular periphery face 24a is bonded, and a periphery part back face of the glass 27 contacting with the seat face 24b is bonded to the edge member 21.

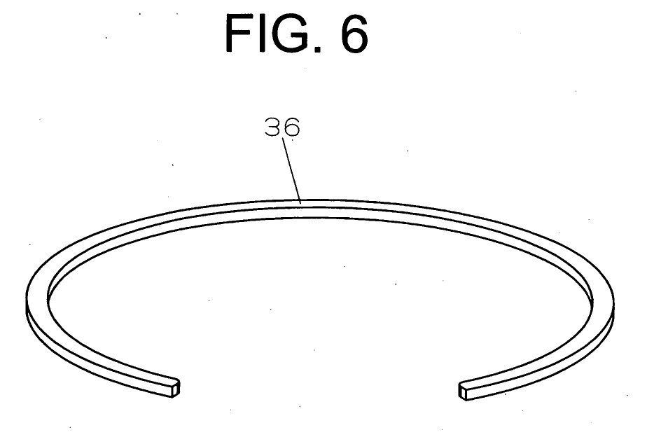

The edge member 21 to which the glass 27 has been mounted like this is detachably attached to the case band 15 by using a snap ring 36 shown in FIG. 6 and so forth. The snap ring 36 is formed in a C-shaped form by a metal material whose section is rectangle, and elastically deformable. An inner diameter of this snap ring 36 under its free state is larger than a groove inner diameter along an interior face E (refer to FIG. 5) of the attaching groove 22a. An outer diameter of the snap ring 36 is larger than an outer diameter of the tubular part 22 and a diameter of the fitting hole 16 irrespective of whether or not the snap ring 36 is under its free state.

An attachment/detachment of the edge member 21 to/from the case band 15 is implemented as follows under a state that the case back 31 has been detached.

There are explained procedures for attaching the edge member 21, to which the glass 27 and the seal packing 25 have been already incorporated, to the case band 15.

First, the tubular part 22 of the edge member 21 is fitted to the fitting hole 16 of the case band 15 from the front side of the case band 15. Under this state, the back face of the cover part 23 is butted against the edge receiving face 17 while compressing the seal packing 25 having been disposed between the edge receiving face 17 of the front side end part 15a and the cover part 23 of the edge member 21. Accompanying it, the tip part of the tubular member 22 is inserted into the fitting hole 16, and a wall face F (refer to FIG. 5) remote from the tubular part 22 tip of the attaching groove 22a is disposed so as to be continuous in the same plane to the engaging back face 18 of the front side end part 15a in an approximately the same height as this engaging back face 18.

Next, while this state is being held intact, the snap ring 36 is accommodated in the case band 15 from the back face opening of the case band 15, and this snap ring 36 is pushed to an outer periphery of the tubular part 22 to thereby fit it to the fitting groove 22a. In this case, by the taper face 22b of a tip site outer periphery of the tubular part 22, since the snap ring 36 is fitted in its inner periphery side site to the attaching groove 22a after it is smoothly, elastically deformed in a direction expanding its diameter, the snap ring 36 can be easily attached to the attaching hole 22a only by pushing it.

By the attachment of the snap ring 36 in this manner, since an outer periphery site of this snap ring 36 is butted against the engaging back face 18 of the front side end part 15a, the edge member 21 is mounted to the case band 15 as shown in FIG. 2 with the front side end part 15a of the case band 15 being nipped in a thickness direction by the snap ring 36 and the cover part 23 of the edge member 21. By this attachment, the glass 27 faces on the dial 14.

Under this state, the snap ring 36 having been fitted to the attaching groove 22a maintains its elastic deformation in a direction expanding its diameter, and the butting of the snap ring 36 against the engaging back face 18 is strengthened by an elastic repulsion force of the seal packing 25 under a compressed state. For this reason, since the snap ring 36 maintains its stable state without rattling, an attaching state of the edge member 21, to which the glass 27 has been fixed, to the case band 15 is stabilized as well. Further, since the seal packing 25 between the cover part 23 and the edge receiving face 17 is still nipped under the compressed state, a liquid tightness between the edge member 21 and the case band 15 can be ensured.

Next, procedures for detaching the edge member 21 from the case band 15 will be explained.

By inserting a tool (not shown in the drawing) from the back face opening of the case band 15 under a state that the case back 31 has been detached and catching this tool to an end part of the snap ring 36, this end part is operated in such a direction that the snap ring 36 is opened as shown by an arrow mark in FIG. 3. In this case, it is desirable to gradually advance a work for opening the other site of the snap ring 36 while supporting a site of the snap ring 36, which has been already detached from the attaching groove 22a, under a state that it has been slantingly intersected to the tip part of the tubular part 22. By this, since the snap ring 36 is detached from the tubular part 22 of the edge member 21 and thus the holding of the edge member 21 with respect to the case band 15 is released, it is possible thereafter to detach the edge member 21 by drawing out it from the case band 15.

According to the detachment procedures like this, since it is unnecessary to detach the edge member 21 by wrenching the edge member 21 from the front side of the case band 15, there is no fear that the edge member 21 and the front side end part 15a of the case band 15 are damaged.

Since it is possible to attach/detach the edge member 21 to/from the case band 15 as mentioned above, in a case where the edge member 21 and the glass 27 have been impaired, it is possible to exchange the edge member 21 and the glass 27, which are exchange objects, by detaching them from the case band 15 by the already mentioned procedures. Similarly, also in a case where a waterproof/dustproof performance of the seal packing 25 has decreased due to a long period use of the wristwatch 11, after the edge member 21, to which the glass 27 has been fixed, has been detached from the case band 15 by the already mentioned procedures, it is possible to exchange the seal packing 25 which is similarly the exchange object without accompanying the edge member 21, to which the glass 27 has been fixed, and the case band 15. Accordingly, in each of these cases, since it becomes unnecessary to discard at least the case band 15 together with an exchange component, an exchange expense for a repair client can be reduced.

The already-mentioned attachment/detachment of the snap ring 36 to/from the tubular part 22 of the edge member 21 is performed without giving an excessive strain to the edge member 21. By this, there is no fear that, when the edge member 21 is attached/detached to/from the case band 15, the strain of the edge member 21 is exerted on a bonding part of the glass 27 and thus the glass 27 is exfoliated. Like this, since an action exfoliating the bonding does not work when the edge member 21 is attached/detached, a thickness of the edge member 21 can be thinned. By it, it is possible to intend to thin the whole of the wristwatch 11. And, even if the edge member 21 is thinned, in addition to the fact that the periphery face of the glass 27 is bonded to the annular periphery face 24a of the annular step part 24 along its thickness direction, since a periphery part back face of the glass 27 is bonded to the seat face 24b of the annular step part 24 and a bonding area of the glass 27 with respect to the edge member 21 can be largely ensured, it is possible to certainly fix the glass 27 to the edge member 21.

Incidentally, in a case where the glass 27 is attached to the edge member 21 while an annular elastic packing is nipped between the periphery face of the glass 27 and the annular periphery face 24a of the annular step part 24 under its compressed state, the seat face 24b of the annular step part 24 cannot be used as a fixing face. For this reason, it is necessary to obtain a necessary glass holding force by increasing a height of the annular periphery face 24a and, therefore, it is obliged to thicken the edge member 21 in comparison with the present embodiment.

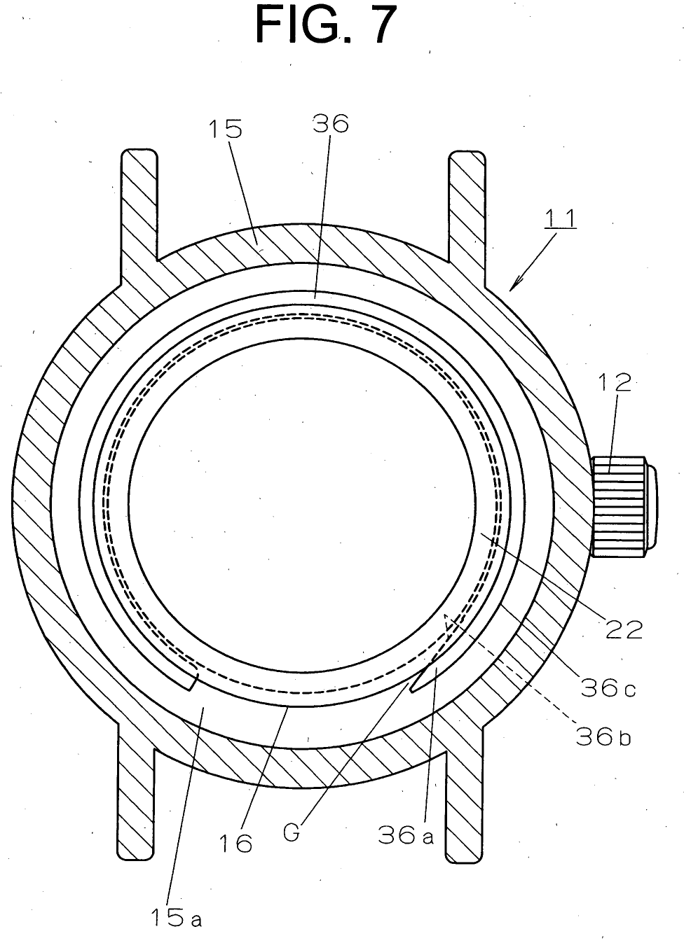

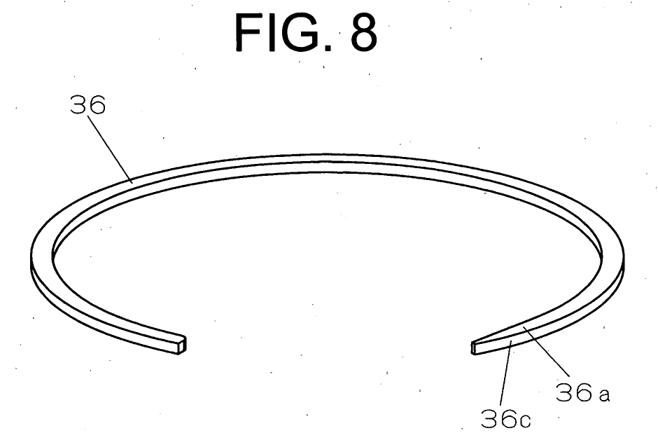

A second embodiment of the present invention is explained by using FIG. 7 and FIG. 8. Since the second embodiment is the same as the first embodiment except matters explained below, the same reference numeral is applied to the same constitution as the first embodiment and its explanation is omitted.

In the second embodiment, an operating part 36a is formed in one end part of the snap ring 36. This operating part 36a is formed so as to become tapered as going to its tip. Detailedly, by forming one end part inner periphery face 36b of the snap ring 36 into a slant face, this one end part inner periphery face 36b is gradually approached to one end part outer periphery face 36c of the snap ring 36, thereby forming the tapered operating part 36a. Under a state that the snap spring 36 has been fitted to the attaching groove 22a of the tubular part 22, this operating part 36a is disposed while being protruded under a state that, as shown in FIG. 7, the one end part inner periphery face 36b slantingly intersects with an outer periphery of the tubular part 22 when it is seen from a case back side. By it, a wedge-like tool inserting gap G is formed between this operating part 36a and the tubular part 22.

For this reason, in order to detach the edge member 21 from the case band 15, there can be performed an operation for opening the snap ring 36 by easily inserting a tip of the tool between the tubular part 22 and the snap ring 36. In other words, as already mentioned, since the tool inserting gap G, into which the tool (not shown in the drawing) for detaching the snap ring 36 from the tubular part 22 is inserted, is previously formed, the tip of the tool can be inserted into this tool inserting gap G without requiring an especial labor. By this, thereafter, the snap spring 36 can be easily detached from the tubular part 22 by opening the snap ring 36 while resisting against its elasticity.

Incidentally, the same as the first embodiment can be applied except the matters explained above. Further, in this second embodiment, not only in the one end part of the snap ring 36, but also in the other end part there may be provided the already-mentioned operating part 36a which forms the wedge-like tool inserting gap G between it and the tubular part 22.

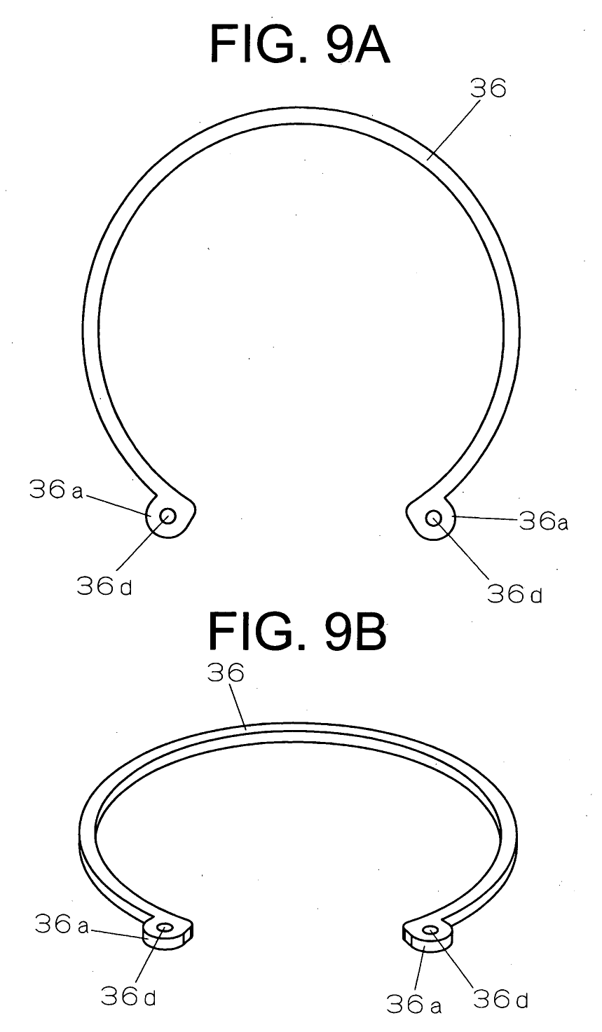

A third embodiment of the present invention is explained by using FIG. 9. Since the third embodiment is the same as the first embodiment except matters explained below, the same reference numeral is applied to the same constitution as the first embodiment and its explanation is omitted.

In the third embodiment, at least one end part, preferably both end parts of the snap ring 36, forms the operating part 36a, and a tool inserting small hole 36d is respectively provided in this operating part 36a. Under the state that the snap spring 36 has been fitted to the attaching groove 22a of the tubular part 22, this tool inserting small hole 36d is disposed while being protruded from the tubular part 22 when it is seen from the case back side. In other words, in the snap ring 36 having been attached to the tubular part 22, the tool inserting small hole 36d is provided in a site having been separated from the tubular part 22.

For this reason, in order to detach the edge member 21 from the case band 15, the operation for opening the snap ring 36 can be performed by easily inserting the tip of the tool into the tool inserting small hole 36d. Like this, since the tool inserting small hole 36d, into which the tool (not shown in the drawing) for detaching the snap ring 36 from the tubular part 22 is inserted, is previously formed, the tip of the tool can be inserted into this tool inserting small hole 36d without requiring the especial labor. By this, thereafter, the snap spring 36 can be easily detached from the tubular part 22 by that the snap ring 36 is opened while resisting against its elasticity. Moreover, by operating the snap ring 36 by simultaneously opening its both ends not only its one end, the snap ring 36 can be more easily detached from the tubular part 22. Incidentally, the same can be applied as the first embodiment except the matters explained above.

According to the present invention, it is possible to provide a timepiece in which it has been made possible to exchange the edge member without accompanying the case band in a case where the edge member, to which the glass has been fixed, has been impaired, or the like.

What is claimed is:

1. A timepiece comprising:
an annular case band which has a front side end part forming a fitting hole, and in which this end part has an edge receiving face around the fitting hole and an engaging back face continuous so as to bulge around the fitting hole;
a case back having been detachably attached to a back side end part of the case band;
an annular edge member which has a tubular part fitted so as to be capable of being inserted into and disengaged from the fitting hole and a cover part overlapped with the edge receiving face, and in which in the tubular part there has been formed an annular attaching groove opening to an outer periphery of the tubular part;
a glass having been fitted and fixed to an annular step part having been formed in the edge member; and
a snap ring which is formed in a C-shaped form by a material having an elasticity, which is detachably attached to the attaching hole, in which the front side end part is nipped between it and the cover part while catching to the engaging back face, and which is attached/detached under a state that the case back has been detached.

2. A timepiece according to claim 1, wherein there has been possessed an annular seal packing having been nipped between the edge receiving face and the cover part under a compressed state.

3. A timepiece according to claim 1, wherein at least one part of the snap ring is made an operating part when the snap ring is detached from the attaching groove by protruding it from the outer periphery of the tubular part and, between the operating part and the tubular part, there has been formed a wedge-like tool inserting gap when it is seen from the case back side.

4. A timepiece according to claim 1, wherein a tool inserting small hole is provided in a site having been separated from the tubular part in at least one end part of the snap ring, and thereby the one end part has been made an operating part when the snap ring is detached from the attaching groove.

5. A timepiece according to claim 1, wherein the glass is fixed to the annular step part by an adhesive.
